(19) United States
(12) Patent Application Publication
(10) Pub. No.: US 2023/0032438 A1
(43) Pub. Date: Feb. 2, 2023

(54) LIVE BAIT STORING AND HOOKING APPARATUS

(71) Applicants: Douglas James Ritchie, Paw Paw, MI (US); Joshua David Ritchie, Paw Paw, MI (US)

(72) Inventors: Douglas James Ritchie, Paw Paw, MI (US); Joshua David Ritchie, Paw Paw, MI (US)

(21) Appl. No.: 17/444,147

(22) Filed: Jul. 30, 2021

(51) Int. Cl. A01K 97/04

(52) U.S. Cl. CPC A01K 97/04

(57) ABSTRACT

A live bait dispenser allows for easy hooking of fish bait without requiring the user to contact the bait. The apparatus includes a storage region, for containing the bait, and a dispensing region, in fluid communication with the storage region, for the bait to position for easy hooking and dispensing. The storage region may be in various shapes and sizes and may include removable or hinged lids to enclose an open top of the storage region. The dispensing region can include a plurality of axial slots that meet with a longitudinal slot to permit hooking and removal of the bait. In some embodiments, a hinged end can be provided to permit the hooked bait, when it is too large to be removed through the longitudinal slot, to be removed from the dispensing region after being hooked.

### BACKGROUND OF THE INVENTION

### 1. Field of the Invention

Embodiments of the invention relate generally to fishing accessories. More particularly, embodiments of the invention relate to an apparatus for storing live bait and positioning the bait for insertion of a hook therein with easy removal of the hooked bait from the apparatus without requiring any direct contact between the user and the bait.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Live bait, such as meal worms, wax worms, crickets, and the like, are often used as bait for fishing. The live bait is often kept in a container and needs to be retrieved by the angler and a hook is then inserted into the live bait. This often requires the user to handle the bait which may not only be disagreeable with the user but may also transfer scents or oils from the user onto the bait, limiting its effectiveness.

In view of the foregoing, there is a need for an improved device for storing, positioning and easy hooking of the bait, followed with removal from the device.

### SUMMARY OF THE INVENTION

Embodiments of the present invention provide a bait dispenser comprising a storage region configured to store bait within an interior thereof; a cap configured to removably cover an open end of the storage region; a dispensing region attached to the storage region; an interior region of the dispensing region in communication with the interior of the storage region; at least one axial slot formed in a front face and extending at least partially through opposing sides of the of the dispensing region, the at least one axial slot open to the interior region of the dispensing region; and a longitudinal slot extending longitudinally along the front face of the dispensing region, the longitudinal slot communicating with the at least one axial slot.

In some embodiments, the at least one axial slot extends entirely through the opposing sides of the dispensing region to terminate at a back member of the dispensing region.

In some embodiments, the longitudinal slot extends to a bottom member of the dispensing region and the bottom member is hingedly attached to the dispensing region.

In some embodiments, the cap is hingedly connected to the open end of the storage region.

In some embodiments, the length and width of the longitudinal slot permits removal of the bait therethrough.

Embodiments of the present invention further provide a bait dispenser comprising a storage region configured to store bait within an interior thereof; a cap configured to removably cover an open end of the storage region; a dispensing region attached to the storage region; an interior region of the dispensing region in communication with the interior of the storage region; a plurality of axial slots formed in a front face and extending at least partially through opposing sides of the of the dispensing region, the plurality of axial slots each open to the interior region of the dispensing region; and a longitudinal slot extending longitudinally along the front face of the dispensing region, the longitudinal slot communicating with each of the plurality of axial slots, wherein the longitudinal slot extends to a bottom member of the dispensing region; and the bottom member is openable to expose the interior region of the dispensing region, permitting the bait to be removed out of the interior region and permitting a hook to slide along the longitudinal slot to exit the dispensing region.

Embodiments of the present invention also provide a method for storing, hooking and dispensing bait comprising placing the bait into an interior of a storage region of a bait dispenser; covering an open end of the storage region with a cap; moving the bait dispenser to allow the bait to move into an interior region of a dispensing region, the interior region in communication with the storage region, the dispensing region attached to the storage region; aligning a hook with at least one axial slot formed in a front face and extending at least partially through opposing sides of the of the dispensing region, the at least one axial slot open to the interior region of the dispensing region, the dispensing region including a longitudinal slot extending longitudinally along the front face of the dispensing region, the longitudinal slot communicating with the at least one axial slot; hooking the bait with the hook; and removing the hooked bait from the interior region.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a bait dispensing device according to an exemplary embodiment of the present invention;

FIG. 2 illustrates a front view of the bait dispensing device of FIG. 1;

FIG. 3 illustrates a close-up view of the bait distributing end of the bait dispensing device of FIG. 1, showing a hook being positioned to retrieve a bait therein;

FIG. 4 illustrates a close-up view of the bait distributing end of the bait dispensing device of FIG. 1, showing the hook inserted into the bait;

FIG. 5 illustrates a close-up view of the bait distributing end of the bait dispensing device of FIG. 1, showing the hooked bait being removed therefrom;

FIG. 6 illustrates a partial perspective view of a bait dispensing device according to an exemplary embodiment of the present invention;

FIG. 7 illustrates a front view of the bait dispensing device of FIG. 6;

FIG. 8 illustrates a close-up view of the bait distributing end of the bait dispensing device of FIG. 6, showing the bait positioned ready to be hooked;

FIG. 9 illustrates a close-up view of the bait distributing end of the bait dispensing device of FIG. 6, showing the bait hooked and a bottom door opened to release the hooked bait;

FIG. 10 illustrates a close-up view of the bait distributing end of the bait dispensing device of FIG. 6, showing the hooked bait being removed out of the opened door;

FIG. 11 illustrates a perspective view of a bait dispensing device with a hinged top door according to an exemplary embodiment of the present invention; and

FIG. 12 illustrates a perspective view of a bait dispensing device with a removable top door according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any device, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a live bait dispenser that allows for easy hooking of fish bait without requiring the user to contact the bait. The apparatus includes a storage region, for containing the bait, and a dispensing region, in fluid communication with the storage region, for the bait to position for easy hooking and dispensing.

The storage region may be in various shapes and sizes and may include removable or hinged lids to enclose an open top of the storage region. The dispensing region can include a plurality of axial slots that meet with a longitudinal slot to permit hooking and removal of the bait. In some embodiments, a hinged end can be provided to permit the hooked bait, when it is too large to be removed through the longitudinal slot, to be removed from the dispensing region after being hooked.

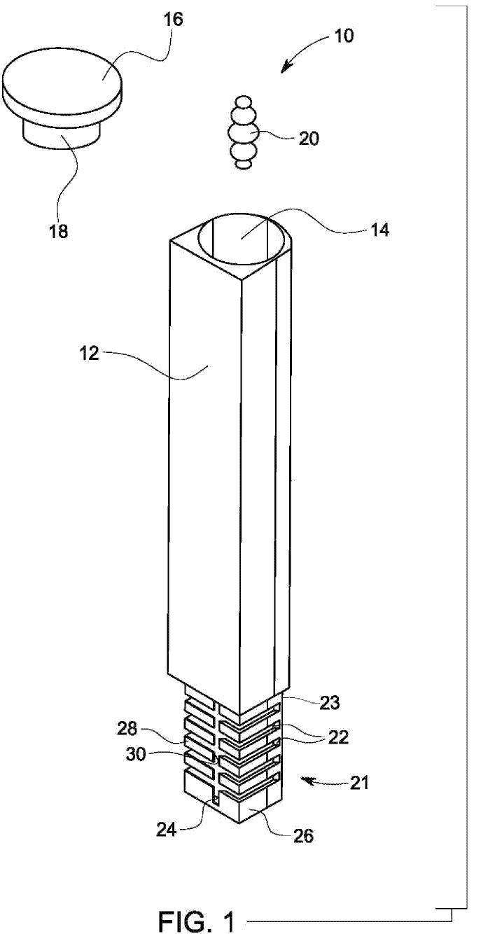

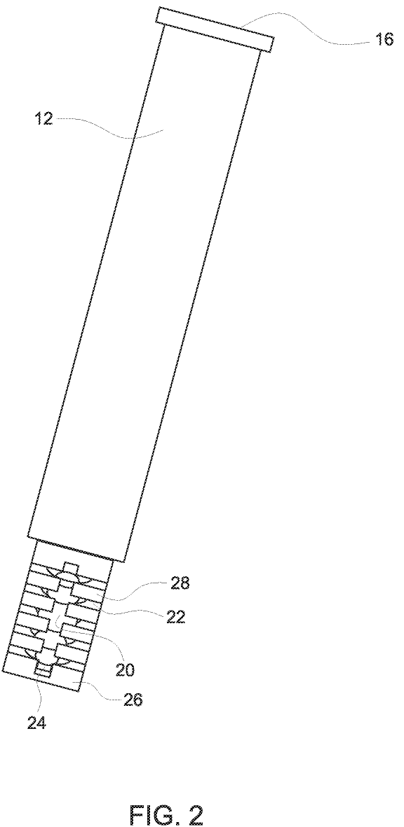

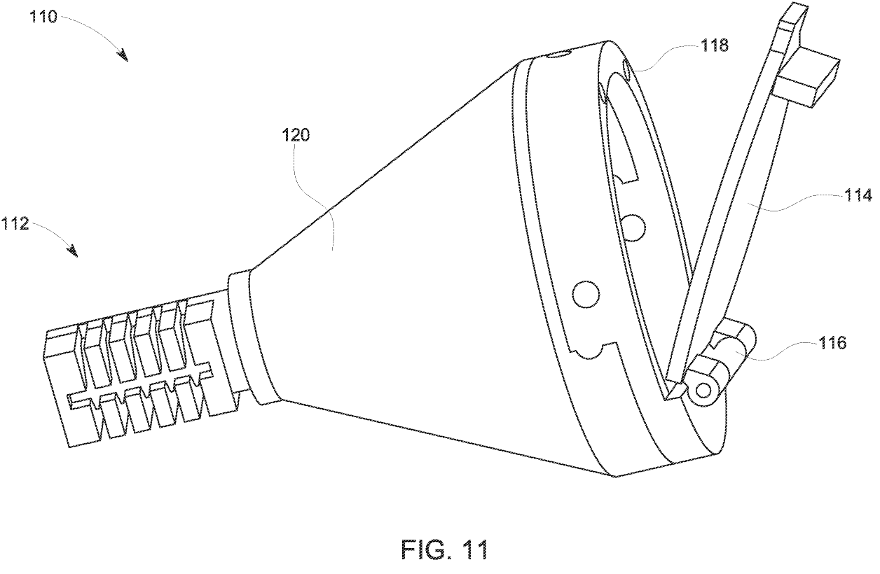

Referring to FIGS. 1 through 5, a bait dispenser 10 includes a storage region 12 and a dispensing region 21 that is in communication with an interior 14 of the storage region 12 such that bait 20 inside the interior 14 can move into the dispensing region 21. The storage chamber 14 can include an open end with a cap 16 that can enclose the interior 14. The cap 16 can attach in various manners, such as with a reduced diameter region 18 that frictionally fits into the open end of the storage region 12. In other embodiments, as discussed below with respect to FIG. 11, the cap may be hingedly connected to the storage region 12.

The dispensing region 21 can include a plurality of axial slots 22 that extend across a width of the dispensing region 21. Typically, the axial slots 22 are formed through a front face of the dispensing region 21 and extend to a back side 23 thereof. Typically, the back side 23 is a solid member. A plurality of fins 28 can extend from the back side 23 with the axial slots 22 being on opposite sides of the fins 28. The fins 28 may be formed in an L-shape, a curved L shape, a semi-circular shape, or the like, extending from the back side 23.

The fins 28 can extend from opposite sides of the back side 23 and terminate at the front fact of the dispensing region 21 to define a longitudinal slot 24 that extends longitudinally along the front face. Typically, the fins 28 terminate from the opposite sides of the back side 23 to face each other, with the longitudinal slot 24 between their opposing faces. The longitudinal slot 24 can connect with each of the axial slots 22 as shown in the Figures.

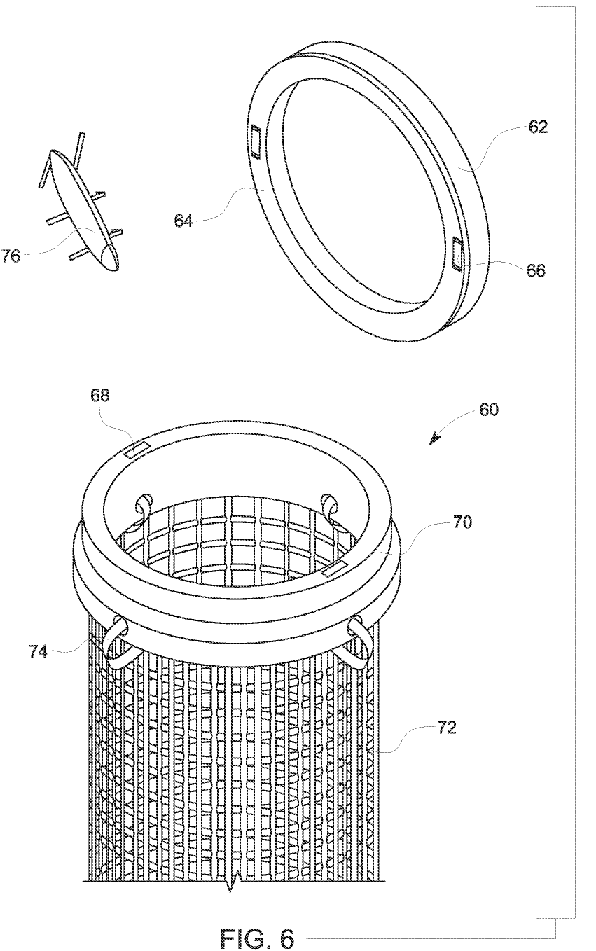

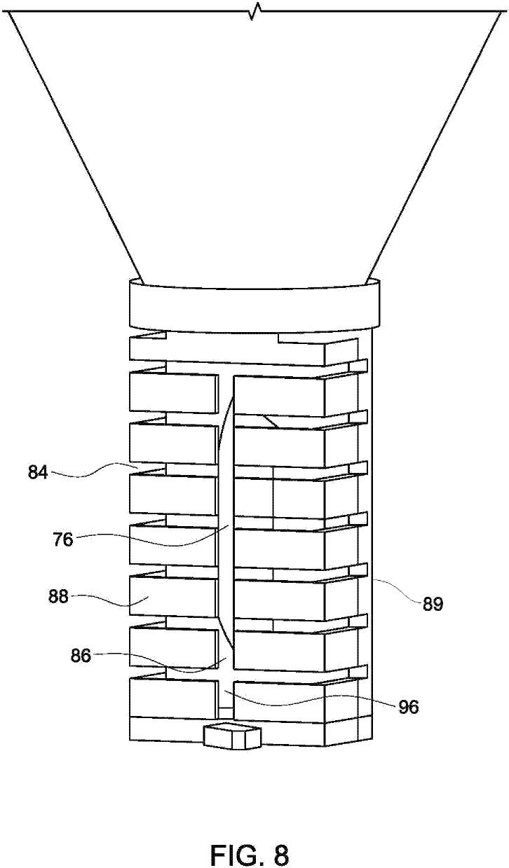

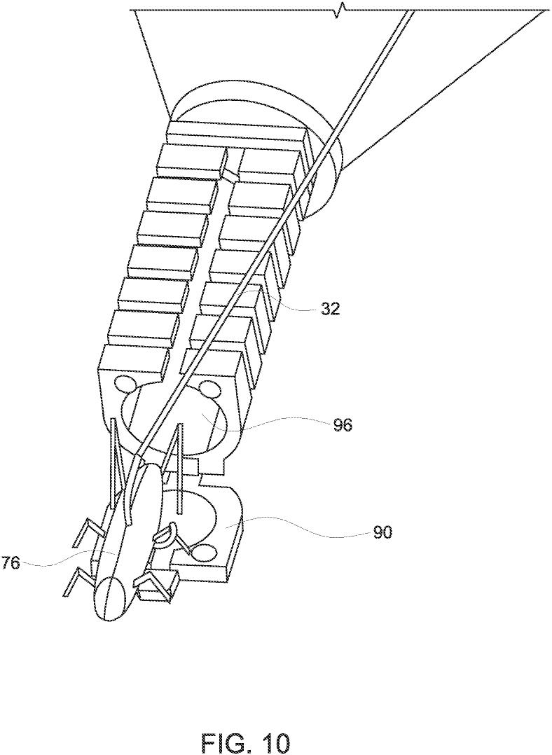

An interior region 30 can be defined by the back side 23, the fins 28 and a bottom member 26. Typically, the bottom member 26 is a solid member. In some embodiments, the bottom member 26 may be hinged, as shown in FIGS. 6-10, described below, to provide access to the interior region 30. Typically, the interior region 30 is sized to house the intended bait to be used with the bait dispenser 10. As shown in FIG. 1, the bait 20 may be a wax worm. Of course, the device 10 may be sized and shaped to store and dispense various types of bait.

In use, the bait 20, typically one piece of bait, can be moved from the storage region 12 into the dispensing region 21. A user may, for example, gently shake or rotate the device 10 to align the bait to fall from the interior 14 of the storage region 12 into the dispensing region 21.

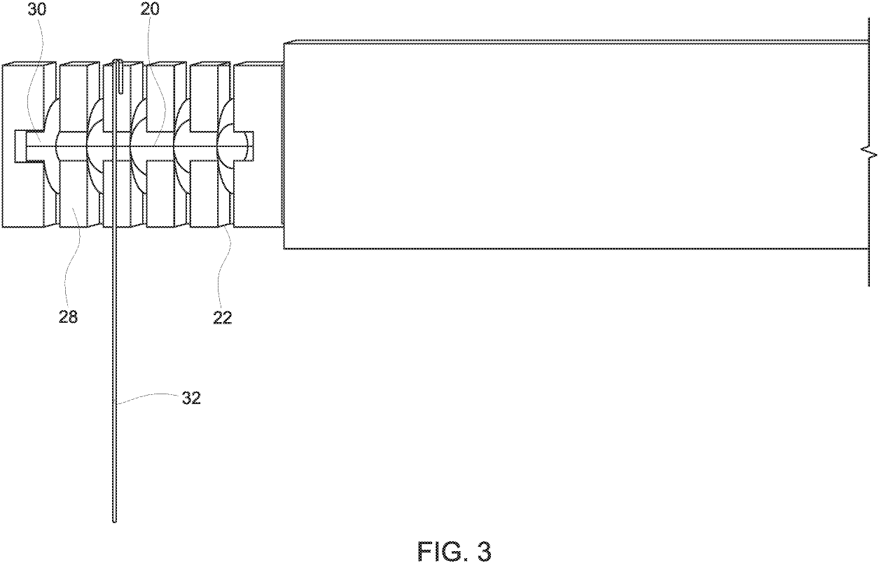

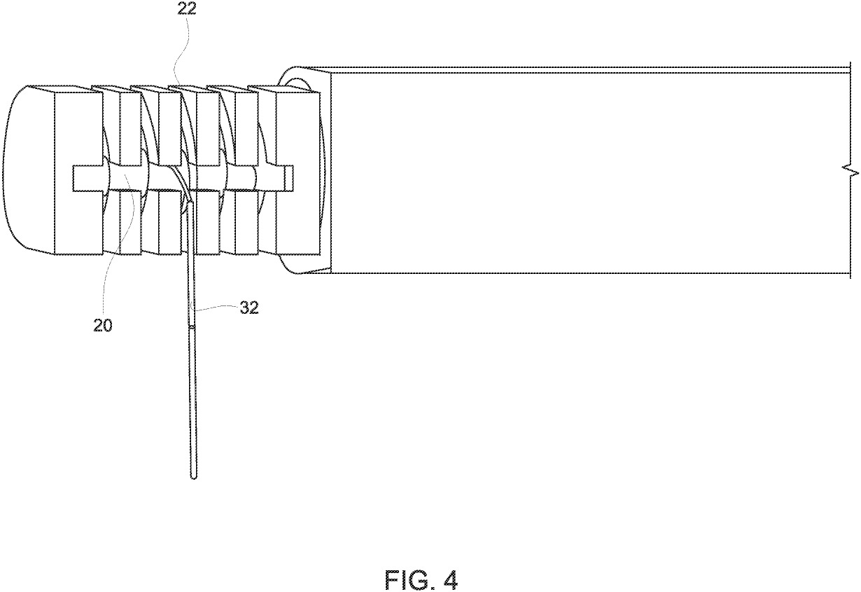

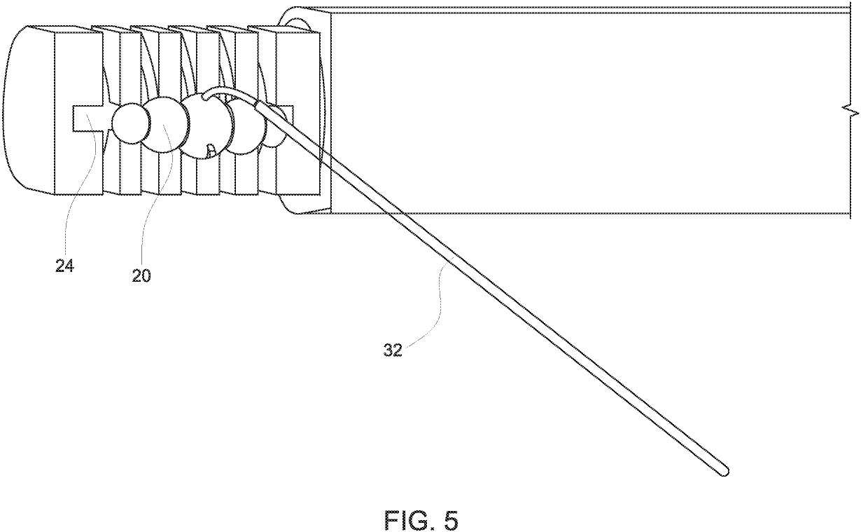

Once the bait 20 is in the interior region 30, the user can insert a hook 32 behind the bait 20 in one of the axial slots 22, as shown in FIG. 3, and insert the hook 32 into the bait 20, as shown in FIG. 4. Once the bait 20 is hooked, as shown in FIG. 5, the bait 20 may be pulled out through the longitudinal slot 24. If the bait is too large to be pulled out of the longitudinal slot 24, the device can include an embodiment where the bottom member 26 is removable or hingedly connected to permit access to the interior region 30 from the bottom of the dispensing region 21. This feature is shown in greater with respect to FIGS. 5 through 10, as discussed below.

Referring now to FIGS. 6 through 10, a bait dispenser 60 can operate in a manner similar to that discussed above. In this embodiment, the cap 62 may include a mechanical connection with connectors 66, 68 used to secure the cap 62 onto the open end 70 of the storage region 72. The connectors 66, 68 may be magnets, ball and socket connectors, flexible pins and receptacles, friction fit members, twist lock members, or the like. In any event, the base 64 of the cap 62 can fit to cover the open end 70 of the storage region 72 and may be removable therefrom to permit the user to add or remove bait to or from the storage region 72.

In the embodiment of FIGS. 6 through 10, the storage region 72 is formed as a mesh to permit visualization of the bait and allow ample air flow through the storage region 72. Such a storage region may be useful for bait 76 such as crickets. Of course, the storage region 72 may be formed from solid material, mesh material, transparent material, or the like. The top of the storage region 72 (as well as the lower member 78) may be attached with a plurality of connectors 74, 80, such as straps, clips or the like. Of course, these members may be attached in any way known in the art.

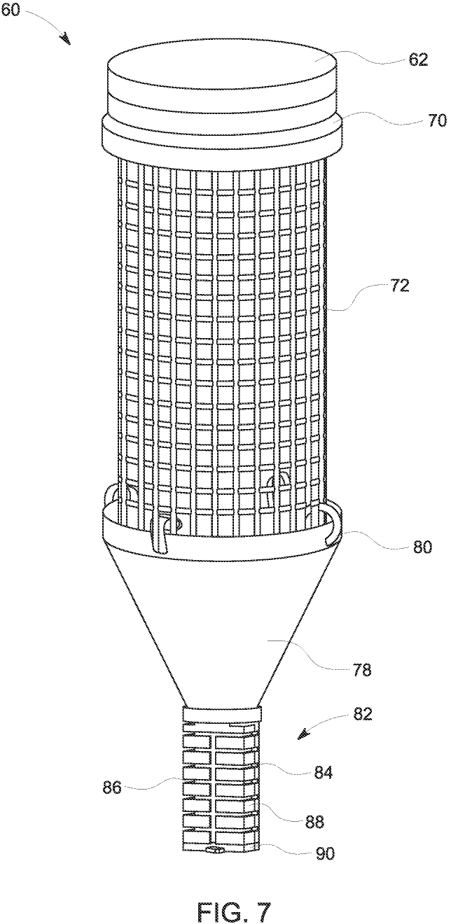

Depending on the diameter of the storage region 72, as shown in FIG. 7, a funnel-shaped lower member 78 can connect the storage region 72 to the dispensing region 82. Of course, other shapes may be used for the lower member 78, or the lower member 78 may not be used and the storage region 72 may directly attach to the dispensing region 82.

The dispensing region 82 may be designed similar to that discussed above, with a plurality of axial slots 84 defined between a plurality of fins 88, with a longitudinal slot 86 disposed along a front face thereof. The fins 88, a bottom member 90, and the back side 89 of the dispensing region 82 can define an interior region 96 into which bait 76 from the storage region 72 can move into for dispensing therefrom.

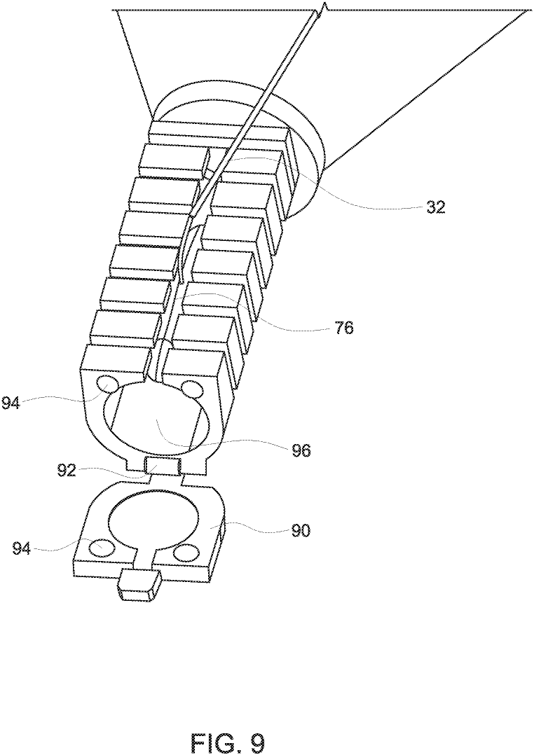

In use, once the bait 76 is positioned in the interior region 96, a user can hook the bait 76 with the hook 32 and open the bottom member 90 to expose the interior region 96, as shown in FIG. 9. The bait 76 can then be slid out of the interior region 96, with the hook 32 traveling along the longitudinal slot 86. The bottom member 90 may include a hinge 92 and connectors 94 to retain the bottom member 90 in a closed configuration. The connectors 94 may be any connector known in the art, including magnets, ball and socket connectors, flexible pins and receptacles, friction fit members, twist lock members, or the like.

Referring now to FIG. 11, a bait dispenser 110 may be similar to that discussed above and can include a lid 114 that can be connected to the storage region 120 with a hinge 116. Connectors 118 may be used to retain the lid 114 in a closed configuration. Like the above embodiments, bait placed into the storage region 120 can be moved into the dispensing region 112 for easy hooking and dispensing therefrom. While FIG. 11 does not show a hinged bottom member at the bottom of the dispensing region 112, such a configuration may be used with the bait dispenser 110 of FIG. 11, as well as the bait dispenser 10 of FIGS. 1 through 5, for example.

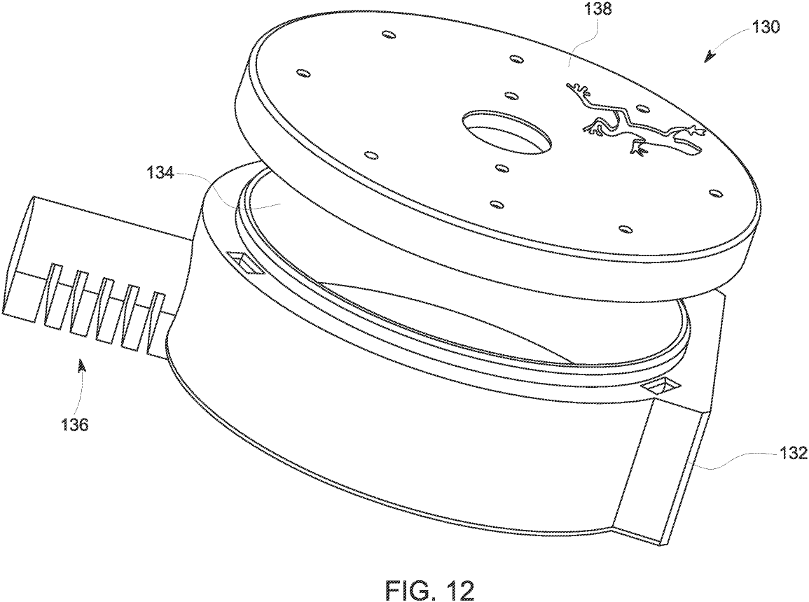

Referring now to FIG. 12, a bait dispenser 130 may be similar to that discussed above and can include a lid 138 that can be connected to the base 132 to create a storage region 134 under the lid 138 when attached to the base 132. Like the above embodiments, bait placed into the storage region 134 can be moved into the dispensing region 138 for easy hooking and dispensing therefrom. While FIG. 12 does not show a hinged bottom member at the bottom of the dispensing region 138, such a configuration may be used with the bait dispenser 130 of FIG. 12. Further, while the lid 138 is completely removable, such a lid may be hinged in manners similar to that described above.

Various materials may be used for the devices discussed above, including plastic, metals such as stainless steel, and the like. The devices may be sized and shaped to hold and dispense various types of bait. In some embodiments, the dispensing region may be formed integrally with the storage region. In other embodiments, the dispensing region may be removably attached to the storage region, where the user may interchange sizes/shapes of the dispensing region to match the size of the bait used, without needing separate storage regions, for example.

In summary, the aspects of the present invention provide an enclosable storage region for storing and/or holding bait therein, where the bait can be permitted to move into a dispensing region, connected to the storage region. The dispensing region includes at least one axial slot and a longitudinal slot that permits hooking and removal of the bait from the dispensing region, where the user never has to directly contact the bait.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A bait dispenser comprising:
a storage region configured to store bait within an interior thereof;
a cap configured to removably cover an open end of the storage region;
a dispensing region attached to the storage region;
an interior region of the dispensing region in communication with the interior of the storage region;
a t least one axial slot formed in a front face and extending at least partially through opposing sides of the of the dispensing region, the at least one axial slot open to the interior region of the dispensing region; and
a longitudinal slot extending longitudinally along the front face of the dispensing region, the longitudinal slot communicating with the at least one axial slot.

2. The bait dispenser of claim 1, wherein the at least one axial slot includes a plurality of slots with fins disposed therebetween.

3. The bait dispenser of claim 2, wherein the fins extend from opposite sides of a solid back member and curve to face each other across the longitudinal slot.

4. The bait dispenser of claim 1, wherein the at least one axial slot extends entirely through the opposing sides of the dispensing region to terminate at a back member of the dispensing region.

5. The bait dispenser of claim 1, wherein the longitudinal slot extends to a bottom member of the dispensing region.

6. The bait dispenser of claim 5, wherein the bottom member is openable to expose the interior region of the dispensing region, permitting the bait to be removed out of the interior region and permitting a hook to slide along the longitudinal slot to exit the dispensing region.

7. The bait dispenser of claim 6, wherein the bottom member is hingedly attached to the dispensing region.

8. The bait dispenser of claim 1, wherein the cap is hingedly connected to the open end of the storage region.

9. The bait dispenser of claim 1, wherein a length of the longitudinal slot is longer than a length of the bait.

10. The bait dispenser of claim 9, wherein a width of the longitudinal slot permits removal of the bait therethrough.

11. The bait dispenser of claim 1, wherein the storage region interconnects to the dispensing region with a funnel-shaped intermedial portion.

12. A bait dispenser comprising:
a storage region configured to store bait within an interior thereof;
a cap configured to removably cover an open end of the storage region;
a dispensing region attached to the storage region;
an interior region of the dispensing region in communication with the interior of the storage region;
a plurality of axial slots formed in a front face and extending at least partially through opposing sides of the of the dispensing region, the plurality of axial slots each open to the interior region of the dispensing region; and
a longitudinal slot extending longitudinally along the front face of the dispensing region, the longitudinal slot communicating with each of the plurality of axial slots, wherein
the longitudinal slot extends to a bottom member of the dispensing region; and
the bottom member is openable to expose the interior region of the dispensing region, permitting the bait to be removed out of the interior region and permitting a hook to slide along the longitudinal slot to exit the dispensing region.

13. The bait dispenser of claim 12, wherein the bottom member is hingedly attached to the dispensing region.

14. The bait dispenser of claim 12, wherein the cap is hingedly connected to the open end of the storage region.

15. A method for storing, hooking and dispensing bait, comprising:
placing the bait into an interior of a storage region of a bait dispenser;
covering an open end of the storage region with a cap;
moving the bait dispenser to allow the bait to move into an interior region of a dispensing region, the interior region in communication with the storage region, the dispensing region attached to the storage region;
aligning a hook with at least one axial slot formed in a front face and extending at least partially through opposing sides of the of the dispensing region, the at least one axial slot open to the interior region of the dispensing region, the dispensing region including a longitudinal slot extending longitudinally along the front face of the dispensing region, the longitudinal slot communicating with the at least one axial slot;
hooking the bait with the hook; and
removing the hooked bait from the interior region.

16. The method of claim 15, wherein the step of removing the hooked bait from the interior region includes removing the bait through at least a portion of the longitudinal slot.

17. The method of claim 15, further comprising:
opening a bottom member of the dispensing region to expose the interior region of the dispensing region; and
removing the bait out of the interior region with the hook moving along the longitudinal slot to exit the dispensing region.

18. The method of claim 15, wherein the at least one axial slot includes a plurality of slots with fins disposed therebetween.

19. The method of claim 15, wherein the at least one axial slot extends entirely through the opposing sides of the dispensing region to terminate at a back member of the dispensing region.
